(19) United States
(12) Patent Application Publication
(10) Pub. No.: US 2025/0371760 A1
(43) Pub. Date: Dec. 4, 2025

(54) METHOD, DEVICE, AND STORAGE MEDIA FOR EFFECT CREATION

(71) Applicant: Beijing Zitiao Network Technology Co., Ltd., Beijing (CN)

(72) Inventors: Yiming Luo, Beijing (CN); Xunpeng Yin, Beijing (CN)

(21) Appl. No.: 18/676,181

(22) Filed: May 28, 2024

(51) Int. Cl. G06T 11/60; G06F 3/04842

(52) U.S. Cl. CPC G06T 11/60; G06F 3/04842

(57) ABSTRACT

Embodiments of the present disclosure provide a solution for effect creation. A method comprises: presenting an effect behavior panel for an effect in an edit mode; providing at least one command edit region in the effect behavior panel, a command edit region comprising an object select box to select at least one object in the effect, an action select box to select an action to be performed by the at least one object, and a trigger select box to select a trigger for triggering the action; and applying a target action command for a target object into the effect based on receiving, within a command edit region, selections of a target object, a target action to be performed by the target object, and a target trigger, the target action command defining that the target object performs the target action when the target trigger occurs.

### FIELD

The disclosed example embodiments relate generally to the field of computer science, particularly to a method, device, and storage medium for effect creation.

### BACKGROUND

More and more applications are being designed to provide various services to users. For example, a user can post, view, and create various types of content in applications, including multimedia content with an effect, such as a video, an image, an image collection, and the like. During interaction of users, various types of effects are communicated. The effects may be designed, previewed, and adjusted by a creator in a relevant application for use by the effect creators.

### SUMMARY

In a first aspect of the present disclosure, there is provided a method. The method comprises: in response to an effect behavior editing request, presenting an effect behavior panel for an effect in an edit mode; providing at least one command edit region in the effect behavior panel, a command edit region comprising an object select box to select at least one object in the effect, an action select box to select an action to be performed by the at least one object, and a trigger select box to select a trigger for triggering the action; and applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

In a second aspect of the present disclosure, there is provided an electronic device. The device comprises at least one processing unit; and at least one memory coupled to the at least one processing unit and storing instructions executable by the at least one processing unit, the instructions, upon execution by the at least one processing unit, causing the device to perform the steps of the method of the first aspect.

In a third aspect of the present disclosure, there is provided an apparatus. The apparatus comprises: means for, in response to an effect behavior editing request, presenting an effect behavior panel for an effect in an edit mode; means for providing at least one command edit region in the effect behavior panel, a command edit region comprising an object select box to select at least one object in the effect, an action select box to select an action to be performed by the at least one object, and means for a trigger select box to select a trigger for triggering the action; and applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

In a fourth aspect of the present disclosure, a non-transitory computer-readable storage medium is provided. The non-transitory computer-readable storage medium has a computer program stored thereon which, upon execution by an electronic device, causes the device to perform actions comprising: in response to an effect behavior editing request, presenting an effect behavior panel for an effect in an edit mode; providing at least one command edit region in the effect behavior panel, a command edit region comprising an object select box to select at least one object in the effect, an action select box to select an action to be performed by the at least one object, and a trigger select box to select a trigger for triggering the action; and applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flow chart of a process for effect creation in accordance with some embodiments of the present disclosure;

FIGS. 3A-3J illustrate some example effect creation pages in accordance with some embodiments of the present disclosure;

FIG. 4 illustrates a block diagram of an apparatus for effect creation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

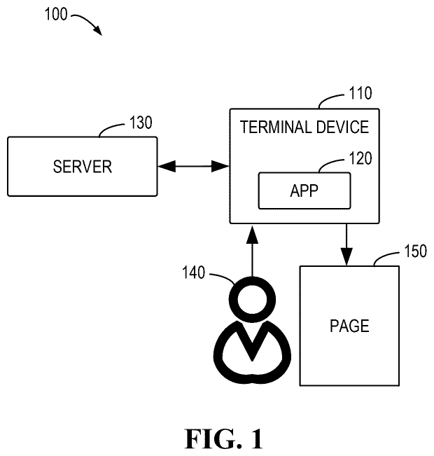

FIG. 1 illustrates a schematic diagram of an example environment 100 in which embodiments of the present disclosure can be implemented. In the example environment 100 of FIG. 1, an application 120 is installed in the terminal device 110. A user 140 may interact with the application 120 via the terminal device 110 and/or an attached device of the terminal device 110.

In some embodiments, the application 120 may be a content sharing application (e.g., a video application that focuses on video sharing), which is capable of providing various types of services to user 140 related to a media content item, including browsing, commenting, forwarding, creating (e.g., shooting and/or editing), publishing the content, and the like. In some embodiments, the application 120 may also be any other suitable application in which media content items can be present. As used herein, each “media content item” includes one or more types of content, such as a video, image, motion graphic, image collection, audio, text, and the like.

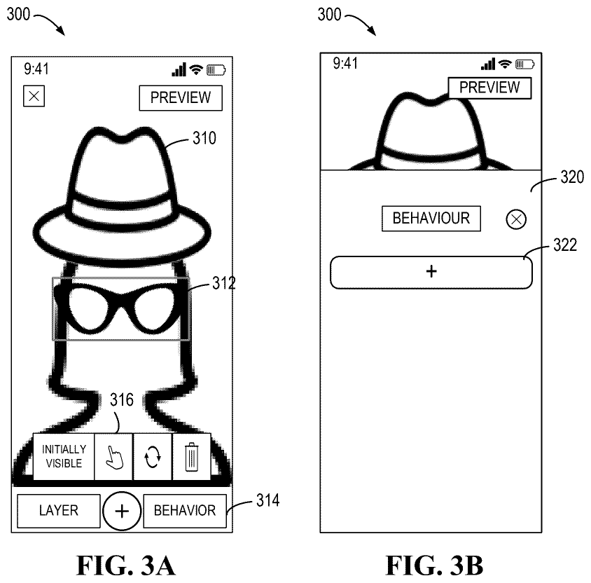

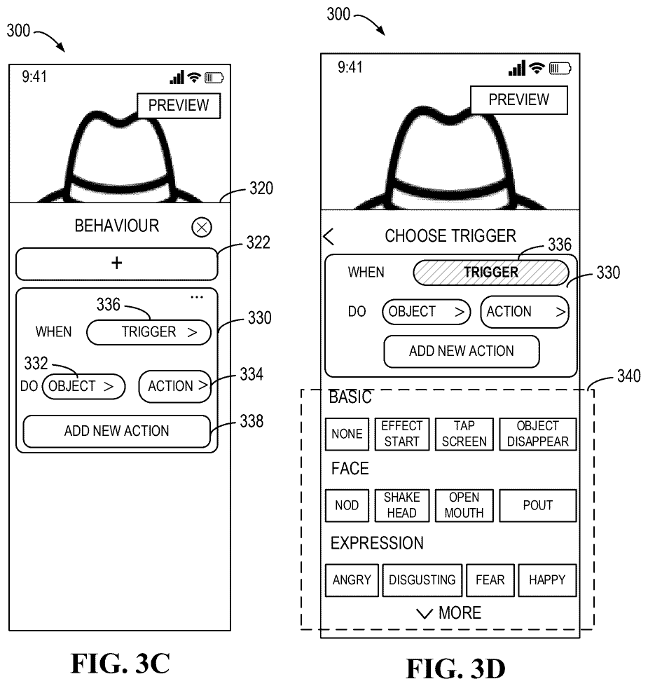

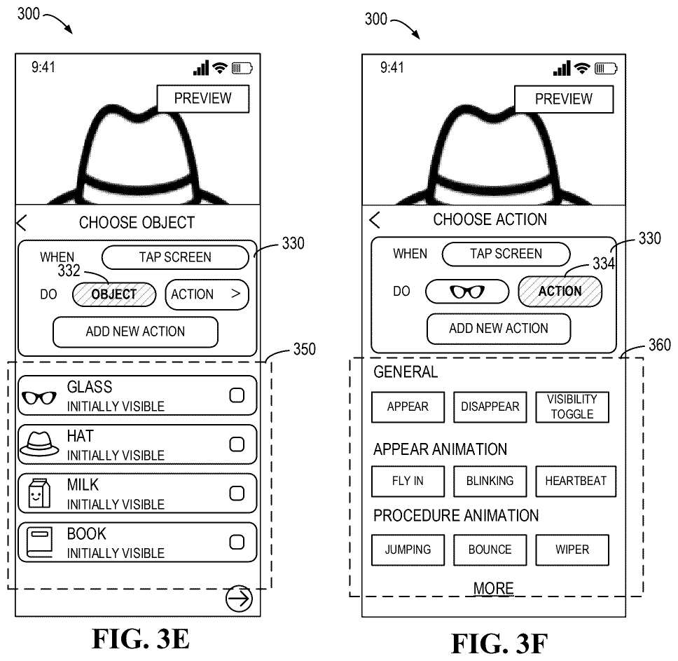

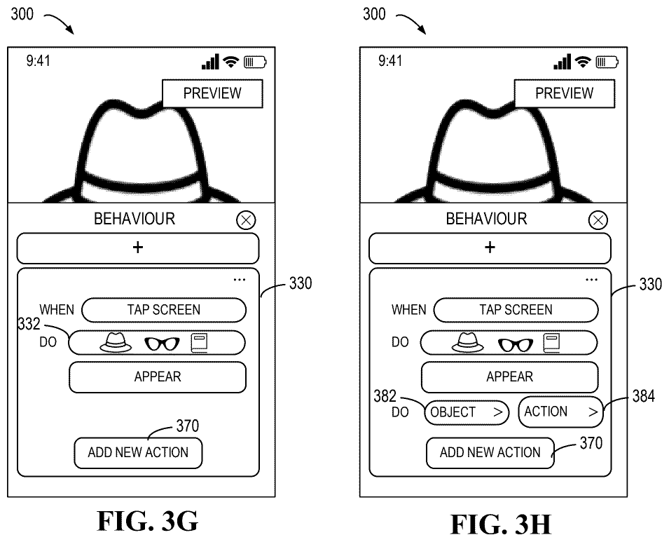

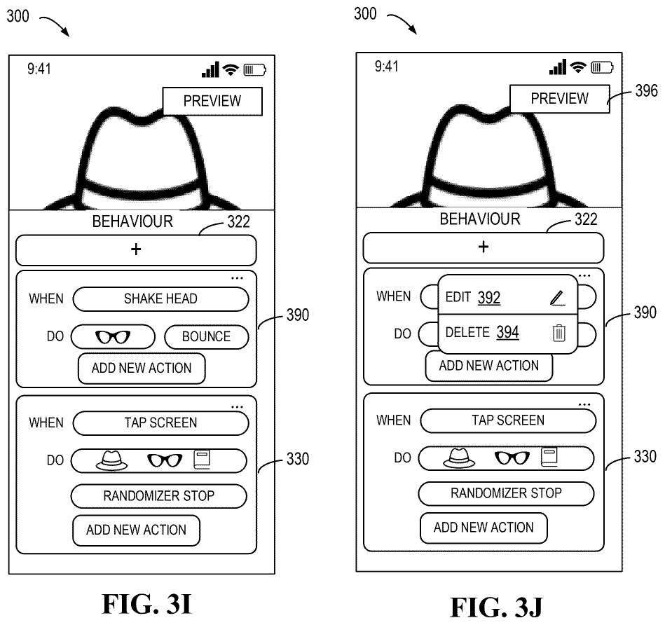

In the example environment 100 of FIG. 1, if the application 120 is active, the terminal device 110 may present a page 150 of the application 120 (e.g., a page 300 as shown in FIG. 3A). The page 150 may include various types of pages that the application 120 can provide, such as a content presenting page, a content creation page, a content publishing page, a messaging page, a personal home page, an effect creation page and so forth. The application 120 may provide a content viewing function to view various types of content published in the application 120. With a corresponding page, application 120 may provide user 140 with content associated with media content. By appropriate means, such as clicking or selecting a page element, the application 120 may also provide the user 140 with an option to select and switch a presentation mode of the associated content. As used herein, “media content” includes one or more types of content, such as an image, image collection, video, motion graphic, audio, text, and the like.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, e-book device, gaming device, or any combination of the foregoing, including accessories and peripherals for these devices or any combination thereof. In some embodiments, the terminal device 110 can also support any type of user-specific interface (such as “wearable” circuitry). The server 130 can be various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

During the process of creating an effect in media content in the page of an application, a user may need to design control parameters of the effect delicately, in order to produce a desired effect. Some types of effects are expected to design with different types of functions and behaviors, which are usually organized in a completed hierarchical structure, with users navigating through long or short click paths. This increases the design complexity, making the design creator take a long time for creation.

According to embodiments of the present disclosure, an improved solution for effect creation is proposed. According to the solution of embodiments of the present disclosure, in an effect creation page for creating a media content item, in response to an effect behavior editing request, an effect behavior panel is provided. At least one command edit region is provided in the effect behavior panel. Each of the at least one command edit region includes an object select box in which at least one object in the effect, an action to be performed by the at least one object, and a trigger for triggering the action can be selected. Based on a selection of a target object, a selection of a target action to be performed by the target object, and a selection of a target trigger for triggering the target action, a target action command is defined and applied to the target object. This makes it easier for effect creators or designers to quickly create an effect behavior as expected, reducing the time cost and complexity of effect design. The whole effect creation process is easier and user-friendly.

Some example embodiments of the present disclosure will continue to be described below with reference to the accompanying drawings. In the following, some example embodiments of the present disclosure will be described in detail with reference to the accompanying drawings. It should be understood that the pages illustrated in the accompanying drawings are merely examples, and various user interface designs may actually exist. Individual graphical elements on the user interface may have different arrangements and different visual representations. One or more of the elements may be omitted or replaced, and one or more other elements may also be present. Embodiments of the present disclosure are not limited in this regard.

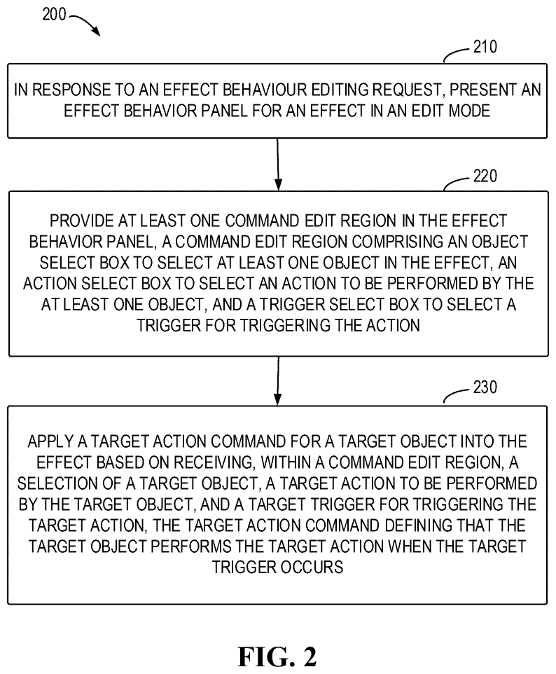

FIG. 2 illustrates a flow chart of a process 200 for effect creation in accordance with some embodiments of the present disclosure. The process 200 can be implemented at a terminal device which operates for effect creation. For purpose of discussion, the process 200 will be described with reference to FIG. 1. Thus, the process 200 is implemented at the terminal device 110 of FIG. 1. In some embodiments, the operations of the terminal device 110 may be implemented or assisted by an application terminal installed in the terminal device 110, and/or by the server 130.

In the scenario of effect creation, it is assumed that the application 120 provides a functionality of allowing the user 140 to create effects. The user 140 may operate via user interfaces provided by the application 120. In the environment 100, the terminal device 110 presents the page 150 of the application 120. In some embodiments, the page 150 presented by the terminal device 110 may be an effect creation page of the application 120, where the media content item is presented in the effect creation page, along with one or more effect objects that have been added. In some embodiments, the effect creation page refers to a page for presenting the media content item and the effect object added, into which the user can add effect objects. The media content items that can be presented in the effect creation page may include various types of media content items.

The pages illustrated in FIGS. 3A to 3J may be presented by the terminal device 110. For ease of discussion, these embodiments will be described with reference to the environment 100 of FIG. 1.

At block 210, in response to an effect behavior editing request, the terminal device 110 presents an effect behavior panel for an effect in an edit mode.

In embodiments of the present disclosure, during the effect creation, the user (effect creator) is allowed to trigger editing of effect behavior, to define one or more effect behavior in the effect. The effect behavior editing request may be triggered in an effect creation page within which the effect in the edit mode is edited. The effect behavior editing request may be triggered by a specific effect behavior editing control provided in the effect edition page, by a gesture detected in the effect page, by a voice command received, and/or by various other ways.

FIG. 3A illustrates an example diagram 300 for an effect creation page 300 according to some embodiments of the present disclosure. As shown in FIG. 3, an effect is edited in the effect creation page 300. A media content item (e.g., an image of a woman) is presented in the effect creation page 300 to show a result of the effect when being applied. The effect is created to include one or more objects, including an object 310 (a graphical element of hat) and an object 312 (a graphical element of a pair of glasses).

Further, an effect behavior editing control 314 is provided in the effect creation page 300 of FIG. 3A, which is triggered to present an effect behavior panel 320 as shown in FIG. 3B. In addition to the effect behavior editing control 314 presented in the effect creation page 300, in some cases, if any one or more of the objects added in the effect is selected, a function panel related to the selected object(s) may be provided and an effect behavior editing control can be included in the function panel. As shown in FIG. 3A, if the object 312 is selected, a function panel with an effect behavior editing control 316 can be provided. By triggering the effect behavior editing control 316, an effect behavior panel 320 as shown in FIG. 3B may be provided.

It would be appreciated that FIG. 3A shows some examples for triggering the effect behavior panel and other controls may be configured for triggering.

At block 220, the terminal device 110 provides at least one command edit region in the effect behavior panel. A command edit region at least includes an object select box to select at least one object in the effect, an action select box to select an action to be performed by the at least one object, and a trigger select box to select a trigger for triggering the action.

The effect behavior panel allows the user to configure an object behavior (also referred to as “action command” or “command”) in the effect by simply selecting one or more objects, defining the action to be performed by the selected object(s) and defining the trigger for triggering the action.

In some embodiments, if the effect behaviour editing request is directed to the effect (e.g., by triggering the effect behaviour editing 314 in FIG. 3A), the effect behavior panel may be presented with no command edit region (as in FIG. 3B) or with at least one command edit region corresponding to at least one action command that is under editing or applied for the effect. In some embodiments, if the effect behaviour editing request is directed to at least one object in the effect (e.g., by triggering the effect behaviour editing 316 in FIG. 3A with the object 312 selected), the effect behavior panel is presented with a command edit region provided therein. In this case, the at least one object is automatically selected within an object select box of the command edit region.

In FIG. 3B, it is assumed that there is no action command defined for the effect in the edit mode. The effect behavior panel 320 includes a command add control 322 to add a command edit region in the effect behavior panel. By triggering the command add control 322, as shown in FIG. 3C, a command edit region 330 is added and provided in the effect behavior panel 320. The command edit region 330 comprises an object select box 332 to select at least one object in the effect, an action select box 334 to select an action to be performed by the at least one selected object, and a trigger select box 336 to select a trigger for triggering the action.

Through the object select box, action select box, and trigger select box, the user can configure the expected object(s), action(s), and trigger for an action command. In some embodiments, by triggering h the object select box, action select box, or trigger select box, a list of candidates are provided for selection. In this way, the action command can be easily and conveniently configured, without applying complicated code-based command creation.

As shown in FIG. 3D, in the command edit region 330, if a trigger operation is detected on the trigger select box 336 (e.g., if the trigger select box 336 is selected), a list of candidate triggers is presented in a region 340 for the user to select. It would be appreciated that only some of the candidate triggers are listed in FIG. 3D, and there may be more, less or different candidate triggers presented for the user. In some embodiments, there may be a library of candidate triggers for the user to search and select. From the library of candidate triggers, the user can find the desired trigger to configure the time, interactive operation, and/or other rules that can trigger the action command that is under editing in the command edit region.

In some embodiments, the candidate triggers can be classified into various types, including, but not limited to, a type of time-related triggers (e.g., the start time, the delay time, etc.), a type of interactive operation triggers (e.g., tapping the screen, a slide-right/left gesture, etc.), a type of action triggers (e.g., nodding, shaking head, etc.,), a type of event triggers (e.g., appearance of an object, disappearance of an object, etc.), and so on.

As shown in FIG. 3E, in the command region 330, if a trigger operation is detected on the object select box 332 (e.g., if the object select box 332 is selected), a list of candidate objects selectable for the effect are presented in a region 350 for the user to select. The list of candidate objects may be those object that are added in the effect, or can be selected to add into the effect. In some embodiments, one or more objects can be selected from the list of candidate objects.

As shown in FIG. 3F, in the command region 330, if a trigger operation is detected on the action select box 334 (e.g., if the action select box 334 is selected), a list of candidate actions is presented in a region 360 for the user to select. The list of candidate actions may be those that are selectable for at least one object selected in the object select box. In this way, the user may not mistakenly select some actions that are not applicable to the selected object. Some example actions may include, but are not limited to, the selected object(s) appearing, disappearing, visibility toggle, and so on.

In some embodiments, the selected trigger, the object(s), and the action may be indicated in the corresponding trigger select box, the object select box, and the action select box so that the selection result can be visible to the user. The selected trigger, the object(s), and the action configured in a command edit region may be configured as an action command. The action command defines that the object(s) will perform the action(s) when the trigger occurs.

In some embodiments, the action command may be configured in an order of configuring the trigger, object(s), and actions. Guidance information may be provided to guide the user to complete the configuration of the action command. Specifically, if a trigger is selected in the trigger select box of a command edit region, the object select box of the command edit region is highlighted, to attract the user to select one or more objects. Further, if one or more objects are selected in the object select box, the action select box is highlighted for selection of an action. Initially, the trigger select box may be highlighted so that the user can be guided to select the trigger first. By sequentially highlighting the trigger select box, the user can get guidance configuring the action command.

As mentioned above, more than one object may be selected for an action. If a plurality of objects are selected in the object select box, the plurality of objects may be presented in the object select box in an order of object selection. Further, the order of the object may be adjusted, e.g., through a drag operation, a select-to-slide operation, and/or other operations. As shown in FIG. 3G, three objects are presented in the object select box and their order can be adjusted through a drag operation or a select-to-slide operation. In some embodiments, when a plurality of objects are selected in an object select box, prompt information, e.g., “drag-to-order” or “slide-left or side right to order”, may be provided in association with the object select box, to prompt the user with the way to reorder the objects.

In some embodiments, if a plurality of objects are selected in the object select box, when presenting a list of candidate actions for the action select box, one or more switching actions may be provided for the plurality of objects. A switching action may specify an action switching template for the plurality of objects, e.g., one object appearing for one second and then another object appearing, random stop and appear one by one, etc. Various action switching templates may be preconfigured for use. In some embodiments, for some specific action switching templates, the action speed is configured as adjustable. If such a switching action is selected for the plurality of objects, then a speed adjustment control may be provided for the user to adjust an action speed corresponding to that switching action, e.g., to control the object appearing or disappearing speed.

In some embodiments, the selected triggers, objects, and actions can be adjusted flexibly through their select boxes. In some embodiments, if one or more actions are invalid or unavailable due to deletion of one or more objects, those actions may be marked as invalid or unavailable.

In some embodiments, more than one action may be configured for a trigger in a command edit region. That is, the effect may be created to allow multiple actions when a trigger is detected. Different actions may be associated with the same or different actions, depending on the object and action selection during the effect creation process. In some examples, an action add control may be provided in the command edit region. In response to a detection of a trigger operation on the action add control in the third command edit region, a further object select box and a further action select box are provided, to allow the user to select one or more further objects and one or more further actions to be performed by the further object(s).

For example, as shown in FIG. 3G, an action add control 370 is provided in the action command edit region 330. By triggering the action add control 370, a new object select box 382 and a new action select box 384 are provided in the action command edit region 330. More objects and action can be selected through the object select box 382 and the action select box 384.

More actions can be defined as required by triggering the action add control. The actions selected in the action select boxes in a command action region are triggered by the same trigger selected in the trigger select box of the command edit region. In some embodiments, the trigger select box, the one or more object select boxes and the one or more action select boxes are provided in a same command card (the same command region), to be distinguished from other action commands. All the actions defined in a command edit region are considered as an action command configured for the effect in the edit mode.

Further, by triggering the command add control (e.g., the command add control 322) for a plurality of times, then a plurality of action command regions may be added in the effect behavior panel, to allow the user to define a plurality of action commands. In some embodiments, if at least one previous command edit region has been presented in the effect behaviour panel, then the new command edit region may be added on top of the at least one previous command edit region. Such arrangement can facilitate the editing operations of the users for new action commands. Then when the editing of the effect is completed and the effect is published, the action commands configured for the effect may be detected and performed in an order from the bottom to the top. Of course, the new command edit region can be located in any other suitable ways.

As shown in FIG. 31, by triggering the command add control 322, a new command edit region 390 is added on top of the previous command edit region 330. A new trigger, object(s), and action(s) may be configured in the command edit region 390.

In some embodiments, it also allows deleting and further editing of the action commands added in the effect behaviour panel. As shown in FIG. 3J, a function panel may be presented through a suitable trigger operation on the command edit region 390. The “delete” control 392 can be triggered to delete the command edit region 390 and thus the corresponding edited action command. The “edit” control 394 can be triggered to further edit the command edit region 390, e.g., to delete one or more actions (and associated objects) in the command edit region 390. In some cases, the “edit” control 394 is provided when a plurality of actions are defined in the command edit region 390.

In some embodiments, a preview function is provided for preview of the action command(s). As shown in FIG. 3J, a preview control 396 is provided. In response to a detection of a trigger operation on the preview control while the effect behaviour panel is provided, a preview of the effect with the action command(s) applied can be presented to the user. In this way, the user (e.g., the effect creator) can check if the effect result is desired and if adjustment is needed. During the preview of the effect, the effect behavior panel can be hidden and then provided when the preview is completed.

Referring back to FIG. 2, after the definition of all the action commands are completed in the effect behaviour panel, at block 220, the terminal device 110 applies a target action command for a target object into the effect based on receiving, within a command edit region, a selection of a target object, a selection of a target action to be performed by the target object, and a selection of a target trigger for triggering the target action. The target action command defines that the target object performs the target action when the target trigger occurs. The action command(s) are used to define the animation behaviour of the effect in the edit mode.

In some embodiments, after the editing of the effect is completed, the effect may be published. In some embodiments, the effect may be published through an effect script file. In response to a detection of a script generation request of the effect, an effect file is generated for the effect, where the effect file at least includes separate node scripts corresponding to the object(s), the action(s), and the trigger(s) applied in the effect. That is, the configuration of the trigger, object(s), and action(s) are decoupled in the script file, and each independent part of the script file is corresponding to an action command.

In some embodiments, if a plurality of action commands are applied for the effect, those action commands are independent from each other. Whenever any of the triggers in the action commands are detected, it indicates that the corresponding action(s) of the object(s) are to be performed.

In some embodiments, the action commands may be parsed into a graph as events. The trigger(s), action(s), and object(s) are parsed as nodes and edges in the graph. A trigger is directed to an action(s) through an edge, with the object(s) marked on the edge. Different action commands are independent from each other in the graph. The effect script file can thus be generated by parsing the graph.

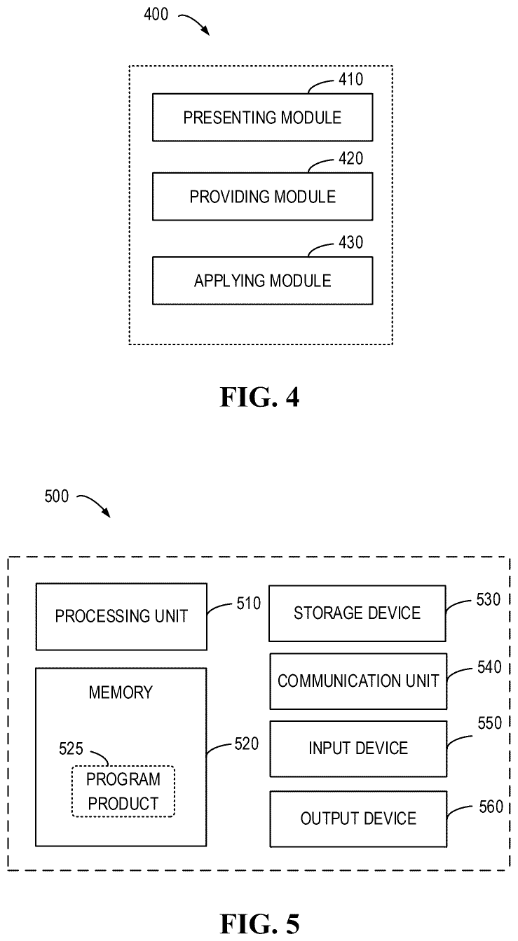

FIG. 4 shows a block diagram of an apparatus 400 for effect creation in accordance with some embodiments of the present disclosure. The apparatus 400 may be implemented, for example, or included at the terminal device 110 of FIG. 1. Various modules/components in the apparatus 400 may be implemented by hardware, software, firmware, or any combination thereof.

As shown, the apparatus 400 includes a presenting module 410 configured to, in response to an effect behavior editing request, present an effect behavior panel for an effect in an edit mode. The apparatus 400 further includes a providing module 420 configured to provide at least one command edit region in the effect behavior panel, a command edit region comprising an object select box to select at least one object in the effect, an action select box to select an action to be performed by the at least one object, and a trigger select box to select a trigger for triggering the action. The apparatus 400 further includes an applying module 430 configured to apply a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

In some embodiments, the presenting module 410 is further configured to, in accordance with a determination that the effect behaviour editing request is directed to at least one first object in the effect, present the effect behavior panel with a first command edit region provided therein, the at least one first object being selected within a first object select box of the first command edit region; and in accordance with a determination that the effect behaviour editing request is directed to the effect, present the effect behavior panel with no command edit region or with at least one command edit region corresponding to at least one action command that is under editing or applied for the effect.

In some embodiments, the apparatus 400 further includes a candidate presenting module configured to, for a second command edit region in the effect behaviour panel, in accordance with a detection of a trigger operation on a second trigger select box of the second command edit region, present a list of candidate triggers; in accordance with a detection of a trigger operation on a second object select box of the second command edit region, present a list of candidate objects that are selectable for the effect; and in accordance with a detection of a trigger operation on a second action select box of the second command edit region, present a list of candidate actions that are selectable for at least one second object selected in the second object select box.

In some embodiments, the apparatus 400 further includes a highlighting module configured to, in accordance with a detection that a second trigger is selected in the second trigger select box, highlight the object select box for selection of at least one second object; and in accordance with a detection that at least one second object is selected in the second object select box, highlight the second action select box for selection of a second action.

In some embodiments, the apparatus 400 further includes a detecting module configured to detect that a plurality of second objects are selected in the second object select box, wherein an order of the plurality of second objects is adjusted through a drag operation or a select-to-slide operation.

In some embodiments, the candidate presenting module configured to, in accordance with a detection that the plurality of second objects are selected in the second object select box and in accordance with a detection of a trigger operation on the second action select box, present at least one switching action that is selectable for the plurality of second objects, a switching action specifying an action switching template for the plurality of second objects.

In some embodiments, the apparatus 400 further includes an adjustment providing module configured to, in accordance with a detection that a target switching action of the at least one switching action is selected for the plurality of second objects, provide a speed adjustment control to adjust an action speed corresponding to the target switching action.

In some embodiments, the apparatus 400 further includes an object providing module configured to, for a third command edit region in the effect behaviour panel, in accordance with a detection of a trigger operation on an action add control in the third command edit region, providing a further object select box to select at least one further object in the effect and a further action select box to select a further action to be performed by the at least one further object, wherein the actions selected in the action select box and the further action select box are triggered by a trigger selected in the trigger select box of the third command edit region.

In some embodiments, the effect behaviour panel comprises a command add control, and the apparatus 400 further includes a command adding module configured to, in accordance with a detection of a trigger operation on the command add control, add a command edit region in the effect behavior panel.

In some embodiments, the command adding module is configured to, in accordance with a determination that at least one previous command edit region has been presented in the effect behaviour panel, add the command edit region on top of the at least one previous command edit region.

In some embodiments, the apparatus 400 further includes a preview providing module configured to, in accordance with a detection of a trigger operation on a preview control while the effect behaviour panel is provided, presenting a preview of the effect with the target action command applied; and a preview presenting module configured to, in accordance with a detection of an exist operation on the preview, presenting the effect behaviour panel.

In some embodiments, the apparatus 400 further includes an effect generating module configured to, in accordance with a detection of a script generation request of the effect, generate an effect file for the effect, the effect file at least comprising separate node scripts corresponding to the target object, the target action, and the target trigger applied in the effect.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the terminal device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method comprising:
in response to an effect behavior editing request, presenting an effect behavior panel for an effect in an edit mode;
providing at least one command edit region in the effect behavior panel, a command edit region comprising an object select box to select at least one object in the effect, an action select box to select an action to be performed by the at least one object, and a trigger select box to select a trigger for triggering the action; and
applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

2. The method of claim 1, wherein presenting the effect behavior panel comprises:
in accordance with a determination that the effect behaviour editing request is directed to at least one first object in the effect, presenting the effect behavior panel with a first command edit region provided therein, the at least one first object being selected within a first object select box of the first command edit region; and
in accordance with a determination that the effect behaviour editing request is directed to the effect, presenting the effect behavior panel with no command edit region or with at least one command edit region corresponding to at least one action command that is under editing or applied for the effect.

3. The method of claim 1, further comprising:
for a second command edit region in the effect behaviour panel,
in accordance with a detection of a trigger operation on a second trigger select box of the second command edit region, presenting a list of candidate triggers;
in accordance with a detection of a trigger operation on a second object select box of the second command edit region, presenting a list of candidate objects that are selectable for the effect; and
in accordance with a detection of a trigger operation on a second action select box of the second command edit region, presenting a list of candidate actions that are selectable for at least one second object selected in the second object select box.

4. The method of claim 3, further comprising:
in accordance with a detection that a second trigger is selected in the second trigger select box, highlighting the object select box for selection of at least one second object; and
in accordance with a detection that at least one second object is selected in the second object select box, highlighting the second action select box for selection of a second action.

5. The method of claim 3, further comprising:
detecting that a plurality of second objects are selected in the second object select box, wherein an order of the plurality of second objects is adjusted through a drag operation or a select-to-slide operation.

6. The method of claim 3, wherein presenting a list of candidate actions comprises:
in accordance with a detection that the plurality of second objects are selected in the second object select box and in accordance with a detection of a trigger operation on the second action select box,
presenting at least one switching action that is selectable for the plurality of second objects, a switching action specifying an action switching template for the plurality of second objects.

7. The method of claim 6, further comprising:
in accordance with a detection that a target switching action of the at least one switching action is selected for the plurality of second objects, providing a speed adjustment control to adjust an action speed corresponding to the target switching action.

8. The method of claim 1, further comprising:
for a third command edit region in the effect behaviour panel,
in accordance with a detection of a trigger operation on an action add control in the third command edit region, providing a further object select box to select at least one further object in the effect and a further action select box to select a further action to be performed by the at least one further object,
wherein the actions selected in the action select box and the further action select box are triggered by a trigger selected in the trigger select box of the third command edit region.

9. The method of claim 1, wherein the effect behaviour panel comprises a command add control, the method further comprising:
in accordance with a detection of a trigger operation on the command add control, adding a command edit region in the effect behavior panel.

10. The method of claim 9, wherein adding a command edit region in the effect behavior panel comprises:
in accordance with a determination that at least one previous command edit region has been presented in the effect behaviour panel, adding the command edit region on top of the at least one previous command edit region.

11. The method of claim 1, further comprising:
in accordance with a detection of a trigger operation on a preview control while the effect behaviour panel is provided, presenting a preview of the effect with the target action command applied; and
in accordance with a detection of an exist operation on the preview, presenting the effect behaviour panel.

12. The method of claim 1, further comprising:
in accordance with a detection of a script generation request of the effect, generating an effect file for the effect, the effect file at least comprising separate node scripts corresponding to the target object, the target action, and the target trigger applied in the effect.

13. An electronic device, comprising:
at least one processing unit; and
at least one memory coupled to the at least one processing unit and storing instructions executable by the at least one processing unit, the instructions, upon execution by the at least one processing unit, causing the electronic device to perform actions comprising:
in response to an effect behavior editing request, presenting an effect behavior panel for an effect in an edit mode;
providing at least one command edit region in the effect behavior panel, a command edit region comprising an object select box to select at least one object in the effect, an action select box to select an action to be performed by the at least one object, and a trigger select box to select a trigger for triggering the action; and
applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.

14. The electronic device of claim 13, wherein presenting the effect behavior panel comprises:
in accordance with a determination that the effect behaviour editing request is directed to at least one first object in the effect, presenting the effect behavior panel with a first command edit region provided therein, the at least one first object being selected within a first object select box of the first command edit region; and
in accordance with a determination that the effect behaviour editing request is directed to the effect, presenting the effect behavior panel with no command edit region or with at least one command edit region corresponding to at least one action command that is under editing or applied for the effect.

15. The electronic device of claim 13, wherein the instructions, upon execution by the at least one processing unit, further cause the electronic device to perform:
for a second command edit region in the effect behaviour panel,
in accordance with a detection of a trigger operation on a second trigger select box of the second command edit region, presenting a list of candidate triggers;
in accordance with a detection of a trigger operation on a second object select box of the second command edit region, presenting a list of candidate objects that are selectable for the effect; and
in accordance with a detection of a trigger operation on a second action select box of the second command edit region, presenting a list of candidate actions that are selectable for at least one second object selected in the second object select box.

16. The electronic device of claim 15, wherein the instructions, upon execution by the at least one processing unit, further cause the electronic device to perform:
in accordance with a detection that a second trigger is selected in the second trigger select box, highlighting the object select box for selection of at least one second object; and
in accordance with a detection that at least one second object is selected in the second object select box, highlighting the second action select box for selection of a second action.

17. The electronic device of claim 15, wherein the instructions, upon execution by the at least one processing unit, further cause the electronic device to perform:
detecting that a plurality of second objects are selected in the second object select box, wherein an order of the plurality of second objects is adjusted through a drag operation or a select-to-slide operation.

18. The electronic device of claim 15, wherein presenting a list of candidate actions comprises:
in accordance with a detection that the plurality of second objects are selected in the second object select box and in accordance with a detection of a trigger operation on the second action select box,
presenting at least one switching action that is selectable for the plurality of second objects, a switching action specifying an action switching template for the plurality of second objects.

19. The electronic device of claim 13, wherein the actions further comprise:
for a third command edit region in the effect behaviour panel,
in accordance with a detection of a trigger operation on an action add control in the third command edit region, providing a further object select box to select at least one further object in the effect and a further action select box to select a further action to be performed by the at least one further object,
wherein the actions selected in the action select box and the further action select box are triggered by a trigger selected in the trigger select box of the third command edit region.

20. A non-transitory computer-readable storage medium, having a computer program stored thereon which, upon execution by an electronic device, causes the device to perform actions comprising:
in response to an effect behavior editing request, presenting an effect behavior panel for an effect in an edit mode;
providing at least one command edit region in the effect behavior panel, a command edit region comprising an object select box to select at least one object in the effect, an action select box to select an action to be performed by the at least one object, and a trigger select box to select a trigger for triggering the action; and
applying a target action command for a target object into the effect based on receiving, within a command edit region, a selection of a target object, a selection of a target action to be performed by the target object, and a selection of a target trigger for triggering the target action, the target action command defining that the target object performs the target action when the target trigger occurs.
